(19) United States
(12) Patent Application Publication
(10) Pub. No.: US 2019/0146666 A1
(43) Pub. Date: May 16, 2019

(54) DISPLAY DEVICE

(71) Applicant: SHARP KABUSHIKI KAISHA, Osaka (JP)

(72) Inventors: HIDEKI SHINOBU, Sakai City (JP); NOBUYUKI KAWASE, Sakai City (JP)

(21) Appl. No.: 16/189,215

(22) Filed: Nov. 13, 2018

(30) Foreign Application Priority Data
Nov. 16, 2017 (JP) 2017-220701

(51) Int. Cl. G06F 3/0488; G06F 3/023

(52) U.S. Cl. CPC G06F 3/04886; G06F 3/0233

(57) ABSTRACT

A display device includes a display surface displaying information thereon and an outer surface different from the display surface. The outer surface includes a mark providing a sense of touching different from a sense of touching a surrounding portion thereof such that a touching position of the display device is recognized.

### CROSS REFERENCE TO RELATED APPLICATION

This application claims priority from Japanese Patent Application No. 2017-220701 filed on Nov. 16, 2017. The entire contents of the priority application are incorporated herein by reference.

### TECHNICAL FIELD

The technology described herein relates to a display device with which a position of an input key displayed on a display surface can be found without visual confirmation.

### BACKGROUND

A tablet display device such as a smartphone has been widely used quite rapidly. Unlike a personal computer including a conventional keyboard or a push-button type mobile phone, such a tablet display device includes a virtual keyboard displayed on an information display surface and an input operation is performed through the virtual keyboard. Namely, the virtual keyboard is displayed on the in display surface and the position of each key cannot be confirmed with a sense of touching. Therefore, the position of each key is necessarily confirmed visually when an input operation is actually performed.

A proposal for easily finding a position of each key has been made. For example, an information process device includes a projection in a display area of a specific key on the information display surface such that a position of each key can be known without visually confirming the virtual keys and key input can be performed. A user can recognize a reference position of a finger (a home position) or an between the keys from a position of the projection and perform key input With touch typing. Such an information process device is described in Unexamined Japanese Patent Application Publication. No. 2012-243153.

### SUMMARY

However, if the input keys are not displayed on the information display surface of the information process device, the projection may disturb visibility of the display surface. In performing processes with using the information display surface such as swipe, flick, drag, pinch out, and pinch in, the finger hits the projection and smooth performance may ne hindered by the projection.

To solve such a problem, the projection may be provided on a detachable auxiliary sheet. However, in such a configuration, the auxiliary sheet is required to be mounted on the display surface before using the input keys and required to be removed from the display surface when not using the input keys, which may be troublesome.

The technology described herein was made in view of the above circumstances. An object is to provide a display device with which positions of input keys displayed on a display surface are found without visual confirmation.

A display device according to the technology described herein includes a display surface displaying information thereon and an out surface different from the display surface. The outer surface includes a mark providing a sense of touching different from a sense of touching a surrounding portion thereof such that a touching position of the display device is recognized.

According to the display device of the technology described herein, the mark is included at a specific position on the outer surface. Therefore, a user can know which part of the display device the user is touching by touching an cuter surface of the display device and recognizing difference in feel in of touch of the mark when performing a key input operation. Therefore, a user can know a position of each key from the touching position and perform key input without visually confirming the display surface.

The mark is not disposed on the display surface but included on the outer surface. Therefore, the mark does not disturb visibility of the display surface or does not disturb performance using the display surface.

According to the technology described herein, a display device with which positions of input keys displayed on a display surface are found without visual confirmation.

### BRIEF DESCRIPTION OF THE DRAWINGS

FIG. 1 is a plan view of a display device according to a first embodiment.

FIG. 2 is a plan view of a display device according to a first modification of the first embodiment.

FIG. 3 is a plan view of a display device according to a second modification of the first embodiment.

FIG. 4 is a plan view of a display device according to a second embodiment.

FIG. 5 is a plan view of a display device according to a third embodiment.

FIG. 6 is a plan view of a display device according to a fourth embodiment.

FIG. 7 is a right side view of a display device according to a fifth embodiment.

FIG. 8 is a plan view of a display device according to a sixth embodiment.

FIG. 9 is a right side view of the display device according to the sixth embodiment.

FIG. 10 is a back view of a display device according to a seventh embodiment.

FIG. 11 is a cross-sectional view taken along line A-A in FIG. 10.

FIG. 12 is a cross-sectional view of a display device according to an eighth embodiment.

FIG. 13 is a back view of a display device according to a ninth embodiment.

FIG. 14 is a cross-sectional view of the display device taken along line B-B in FIG. 13.

FIG. 15 is a back view of a display device according to a tenth embodiment.

FIG. 16 is a cross-sectional view of the display device taken along line C-C in FIG. 15.

FIG. 17 is a back view of a display device according to an eleventh embodiment.

FIG. 18 is a cross-sectional view of the display device taken along line D-D in FIG. 17.

FIG. 19 is a cross-sectional view of a display device according to a first modification of the eleventh embodiment.

FIG. 20 is a back view of a display device according to a twelfth embodiment.

FIG. 21 is a back view of a display device according to a first modification of the twelfth embodiment.

FIG. 22 is a back view of a display device according to a second modification of the twelfth embodiment.

FIG. 23 is a back view of a display device according to a thirteenth embodiment.

FIG. 24 is a back view of a display device according to a first modification of the thirteenth embodiment.

FIG. 25 is a back view of a display device according to a fourteenth embodiment.

FIG. 26 is a back view of a display device according to a first modification of the fourteenth embodiment.

FIG. 27 is a plan view illustrating a display device displaying a voice microphone key on a display surface.

FIG. 28 is a back view of a display device according to a fifteenth embodiment.

FIG. 29 is a cross-sectional view of the display device taken along line F-F in FIG. 28.

FIG. 30 is a cross-sectional view of a display device according to a first modification of the fifteenth embodiment.

FIG. 31 is a cross-sectional view of a display device according to a second modification of the fifteenth embodiment.

FIG. 32 is a cross-sectional view of a display device according to a third modification of the fifteenth embodiment.

FIG. 33 is a cross-sectional view of a display device according to a fourth modification of the fifteenth embodiment.

FIG. 34 is a cross-sectional view of a display device according to a fifth modification of the fifteenth embodiment.

### DETAILED DESCRIPTION

### First Embodiment

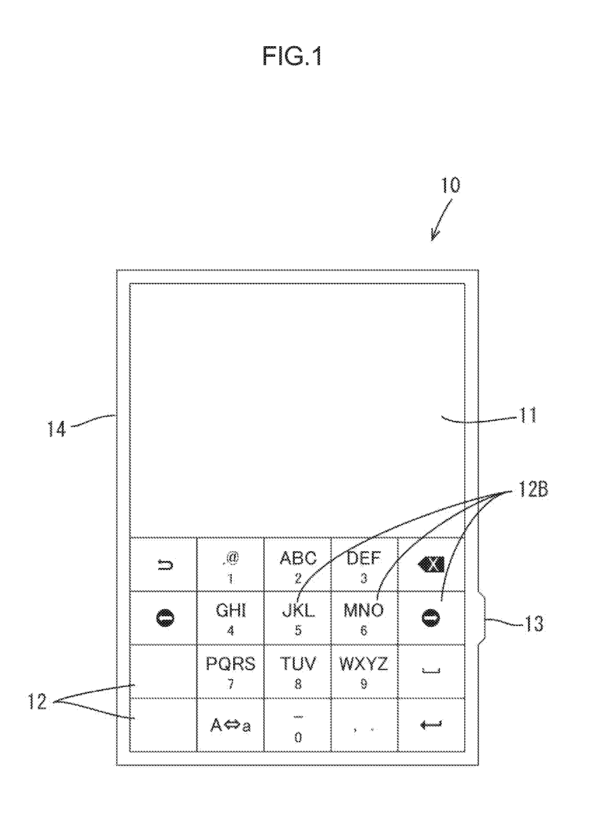

A first embodiment of the present technology will be described with reference to FIG. 1. In the following description, an upper side, a lower side, a right side, and a left side in FIG. 1 is referred to as the upper side, the lower side, the right side, and the left side, respectively. With reference to a direction perpendicular to a paper surface in FIG. 1, a front side with respect to the paper surface is a front side and an opposite side therefrom is a back side.

A display device 10 according to this embodiment has a rectangular flat plate shape and has one surface (a front side surface) as a display surface 11 displaying information thereon. The display device 10 is relatively a small size display device such as a smartphone and can be held with one hand.

When the keys 12 for character input are displayed on the display surface 11, the keys 12 are arranged in a lower area of the display surface 11. The keys 12 are displayed and arranged in five columns with respect to a right-left direction and four rows with respect to an upper-lower direction.

The display device 10 of this embodiment includes a mark 13 on a right side surface of an outer surface 14 for finding a holding position. The mark 13 is a projection projecting outward (toward the right side in FIG. 1) from the right side surface and the projection is included in a region of the right side surface corresponding to (a region adjacent to) keys 12B that are arranged on the second row from the upper side. The mark 13 has a dimension in the upper-lower direction substantially same as that of the key 12B. The projection projects from the right side surface of the outer surface 14, more specifically, projects from a portion of the right side surface adjacent to a specific key (the key 12B on the second row from the above) on the display surface 11 along an extension line parallel to a lower side (an upper side) of the quadrangular display device 10. The projection projects in a direction parallel to the extension line. The mark 13 has a flat projected end surface.

The display device 10 according to the present embodiment includes the mark 13 at the specific position on the outer surface 14. Therefore, a user who holds the display device 10 with one hand can know which part of the display device the user holds with his/her sense of touching the mark 13. Accordingly, the user can know a position of each key 12 from the holding position and perform key input without visually confirming the display surface 11 The holding position or the key input position is less likely to be shifted during the key input because the user confirms the positions by touching the mark 13.

### First Modification of First Embodiment

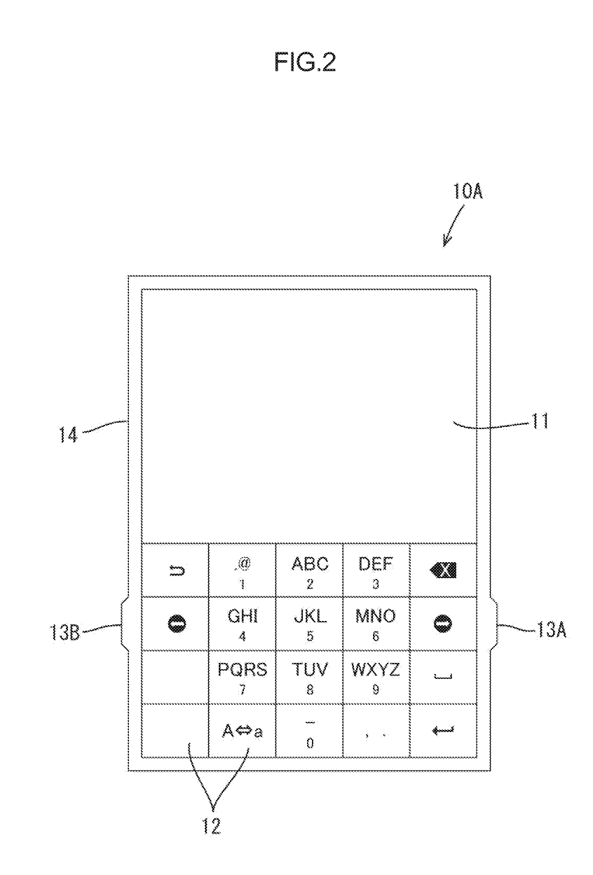

FIG. 2 illustrates a display device 10A according to a first modification of the first embodiment. The display device 10A includes a first mark 13A on a right side surface of the outer surface 14 and a second mark 13B on a left side surface of the outer surface 14. The first mark 13A and the second mark 13B have a similar configuration as that of the mark 13 of the first embodiment. The first mark 13A and the second mark 13B are arranged symmetrically.

According to the display device 10A of this embodiment, the holding position can be known with each of or both of the left and right sides of the display device 10A. Therefore, the position of each key 12 can be exactly found.

### Second Modification of First Embodiment

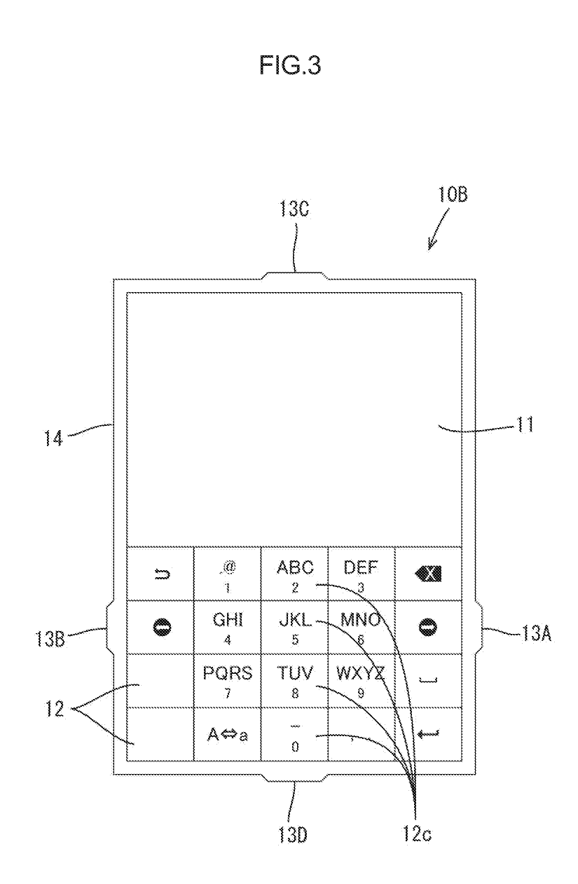

FIG. 3 illustrates a display device 10B according to a second modification of the first embodiment. The display device 10B includes a third mark 13C on an upper side surface of the outer surface 14 and a fourth mark 13D on a lower side surface of the outer surface 14 in addition to the first mark 13A and the second mark 13B on the right and left side surfaces. The third mark 13C and the fourth mark 13D have a configuration similar to that of the first mark 13A and the second mark 13B. The third mark 13C and the fourth mark 13D are arranged on respective middle portions of the upper side surface and the lower side surface, that is, regions of the upper side surface and the lower side surface corresponding to keys 12c on a middle column or a third column.

According to the display device 10B of this embodiment, the position of each of the keys 12 arranged in the right-left direction can be found exactly without visually confirming the keys 12 only by touching the third mark 13C or the fourth mark 13D.

### Second Embodiment

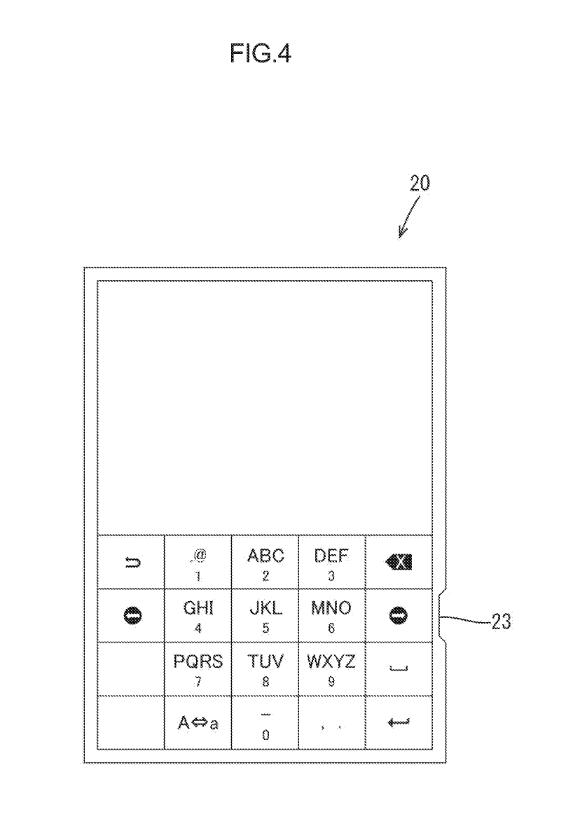

FIG. 4 illustrates a display device 20 according to a second embodiment. The display device 20 includes a mark 23 that is different from that of the first embodiment. The display device 20 includes the mark 23 that is a recess on the right side surface. Other configuration is similar to that of the first embodiment.

According to the display device 20 of this embodiment, a user can know the holding position with a sense of touching the mark 23. Therefore, the position of each key can be exactly found and key input can be performed without visually confirming the keys.

### Third Embodiment

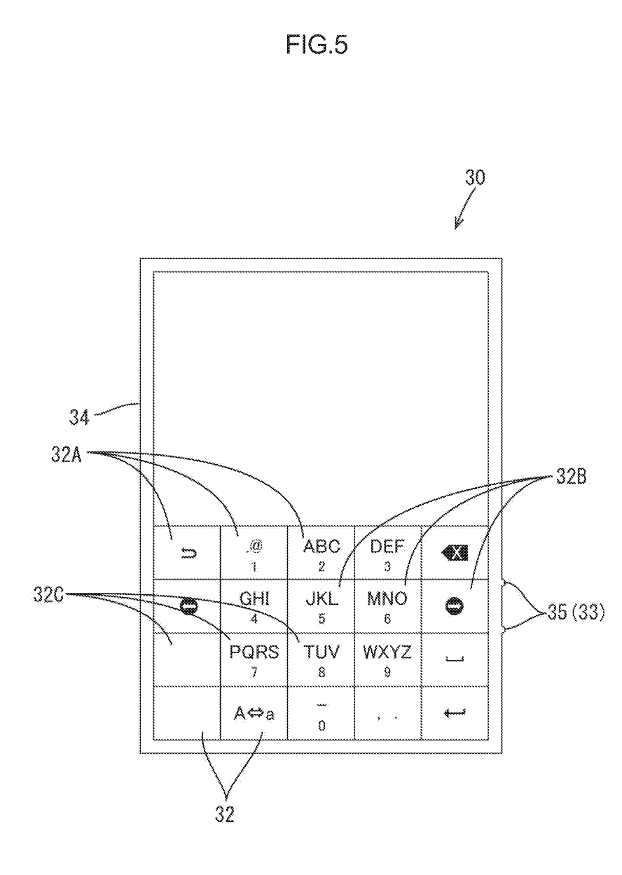

FIG. 5 is a display device 30 according to a third embodiment. The display device 30 includes a mark 33 that is different from that of the first embodiment. The mark 33 is included on the right side surface of an outer surface 34 and includes a pair of linear ribs 35, 35 (an example of the projection). The ribs 35 are disposed on a region of the right side surface corresponding to (adjacent to) keys 32B included in a second row from the above. One of the ribs 35 is disposed on an upper side of the region corresponding to the second row of the keys 32B and another one of the ribs 35 is disposed on a lower side of the region. Namely, the one rib 35 and the other rib 35 define the region corresponding to the second row of the keys 32B from an upper region and a lower region thereof, respectively. The ribs 35 extend aver a thickness dimension of the display device 30. The one rib 35 is disposed on a border between a first row of keys 32A and the second row of the keys 32B from the above and the other rib 35 is disposed on a border between the second row of the keys 32B and a third row of keys 32C from the above.

According to the display device 30 of this embodiment, a user can know the holding position with a sense of touching the pair of linear ribs 35, 35. Therefore, the position of each key can be exactly found and key input can be performed without visually confirming the keys.

### Fourth Embodiment

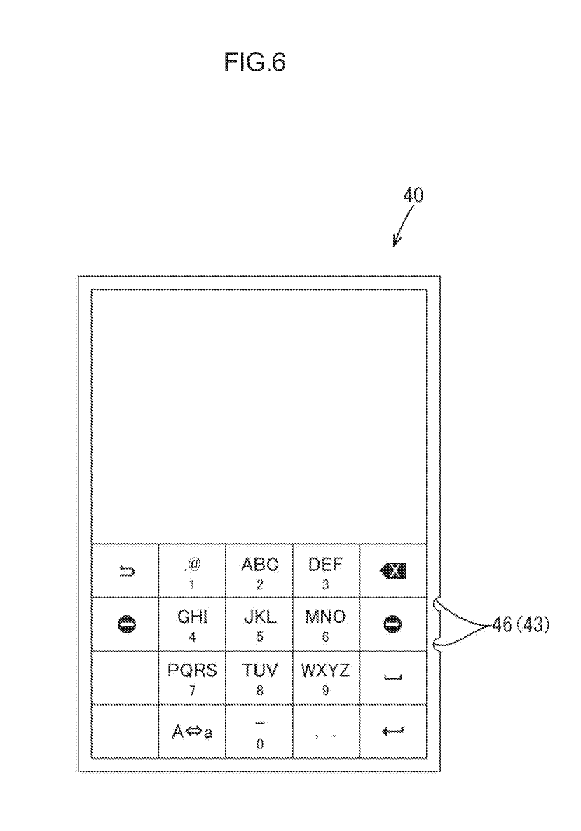

FIG. 6 is a display device 40 according to a fourth embodiment. The display device 40 includes a pair of recesses 46, 46 (an example of a recess) on the right side surface as a mark 43 instead of the pair of ribs 35, 35 of the third embodiment. Each of the recesses 46 extends nearly along a thickness of the display device 40.

According to the display device 40 of this embodiment, a user can know the holding position with a sense of touching the pair of linear recesses 46, 46. Therefore, the position of each key can be exactly found and key input can be performed without visually confirming the keys.

### Fifth Embodiment

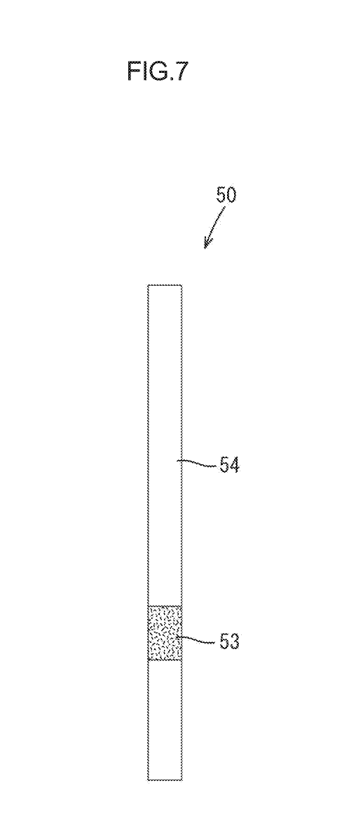

FIG. 7 is a right side view of a display device 50 according to a fifth embodiment. The display device 50 includes a mark 53 on a region of a right side surface corresponding to keys on a second row from the above. The region of the mark 53 has surface roughness (one example of surface properties) greater than surface roughness of other regions such as an upper region and a lower region thereof. Accordingly, the holding position can be recognized by touching the mark 53.

According to the display device 50 of this embodiment, a user can know the holding position with a different sense of touching an outer surface 54 between the mark 53 and other sections. Therefore, the position of each key can be exactly found and key input can be performed without visually confirming the keys.

### Sixth Embodiment

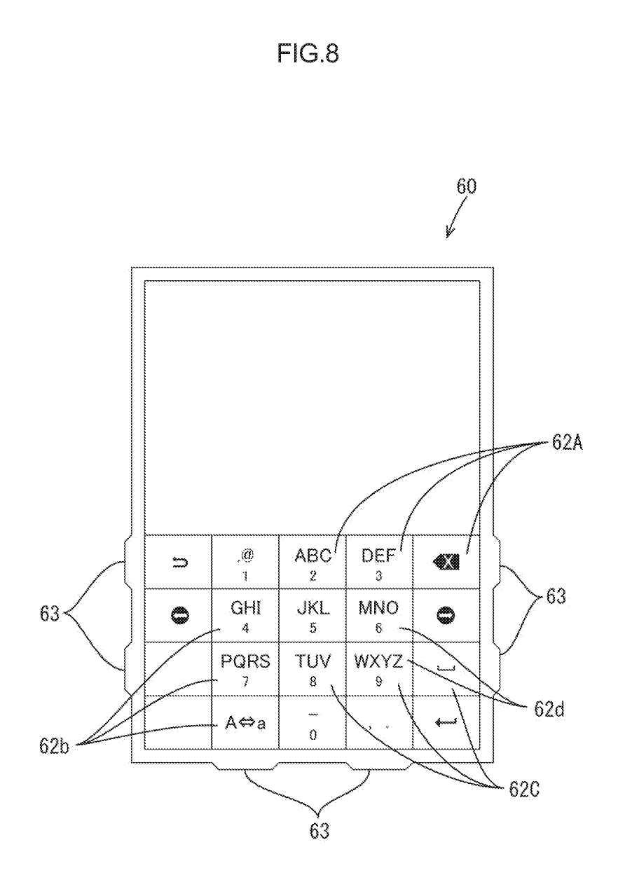

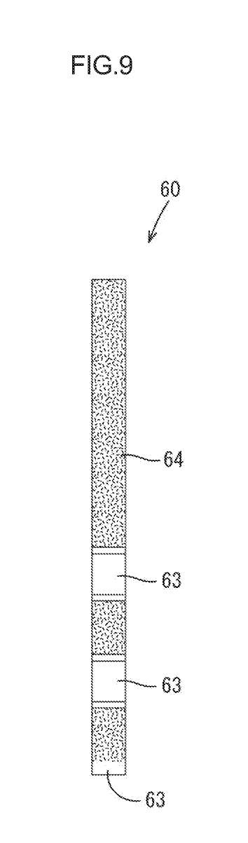

FIG. 8 is a plan view of a display device 60 according to a sixth embodiment and FIG. 9 is a right side view of the display device 60. In this embodiment, the display device 60 includes marks 63 that are projections similar to that of the first embodiment. The display device 60 includes the marks 63 on a right side surface, a left side surface, and a lower side surface thereof. The marks 63 are disposed on regions of the right side surface and the left side surface next to keys 62A of a first row and keys 620 of a third row from the above. The marks 63 are disposed on a region of the lower side surface next to keys 62b of a second column from the left and a region thereof next to keys 62d of a fourth column from the left, respectively.

Furthermore, regions on at least one of the right side surface and the left side surface (regions of an outer surface 64) of the display device 60 other than the marks 63 have surface roughness greater than surface roughness of the marks 63 (see FIG. 9).

According to the display device 60 of this embodiment, a user can know the holding position with a sense of touching the marks 63, which are projections. Further, since the regions other than the marks 63 on the right side surface and the left side surface have greater surface roughness, a user can easily know the holding position with a different sense of touching.

The regions having greater surface roughness are not necessarily the right side surface and the left side surface but may be an upper or lower side surface or an entire region of a back surface may have greater surface roughness.

### Seventh Embodiment

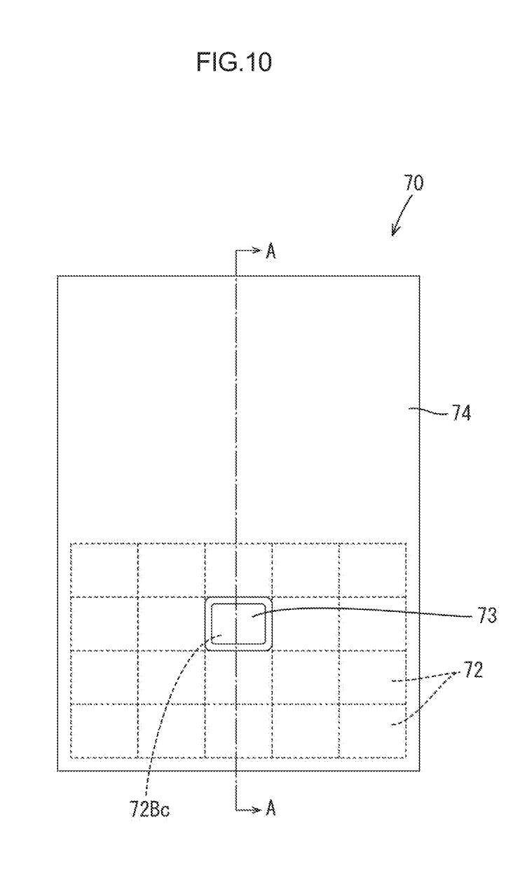

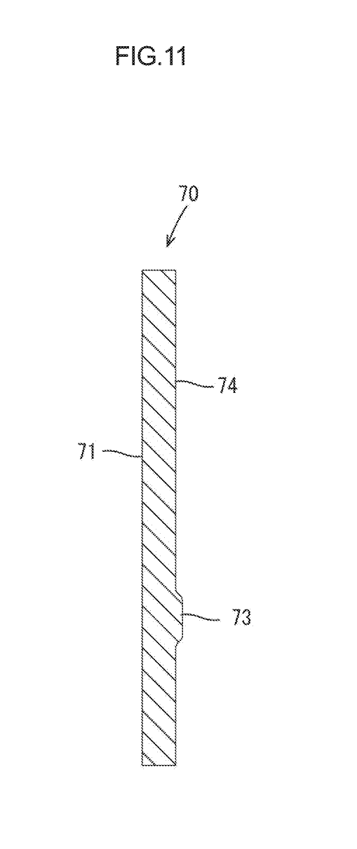

FIG. 10 is a back side view of a display device 70 according to a seventh embodiment and FIG. 11 is a cross-sectional view of the display device 70 taken along line A-A. The display device 70 includes a mark 73 on a back surface thereof in this embodiment.

The mark 73 is a projection that projects from the back side surface (an outer surface 74) of the display device 70. The mark 73 is included on a region of the back side surface corresponding to a key 72Bc on a second row from the above and a third column on a display surface 71 (on a back side of the key 72Bc). The mark 73 has a substantially flat rectangular parallelepiped shape.

According to the display device 70 of the seventh embodiment, a user can recognize the mark 73 with his/her palm and find the position of each key.

### Eighth Embodiment

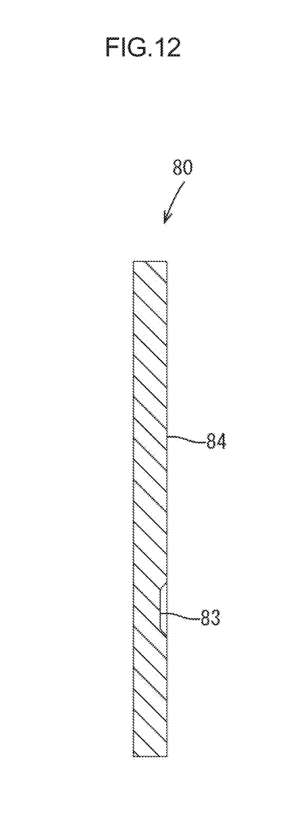

FIG. 12 is a cross-sectional view of a display device 80 of an eighth embodiment. The display device 80 includes a mark 83 in a region same as that of the seventh embodiment. The mark 88 differs from the mark of the seventh embodiment. The mark 83 is not a projection but a recess that is recessed from a back side surface (an outer surface 84) of the display device 80.

### Ninth Embodiment

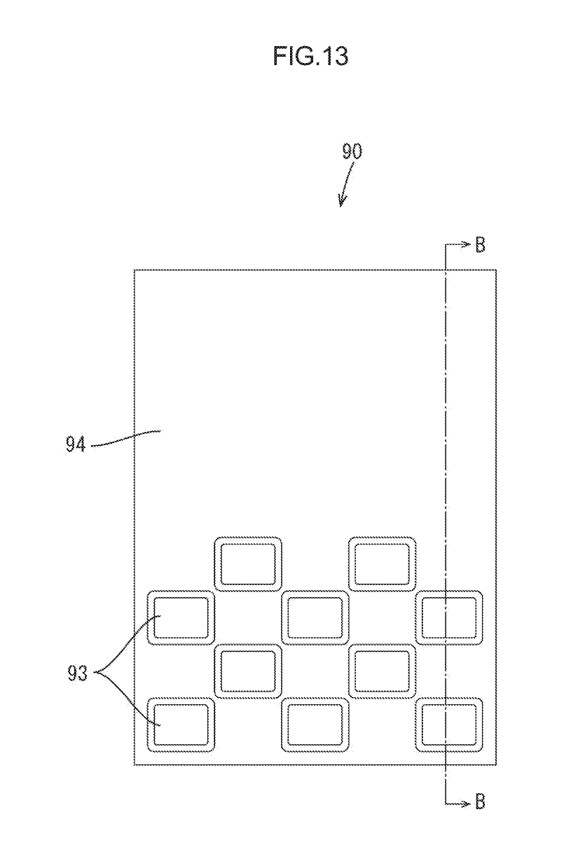

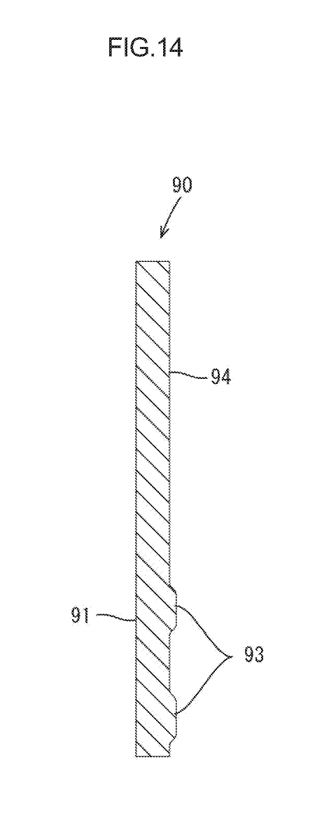

FIG. 13 is a back side view of a display device 90 according to a ninth embodiment and FIG. 14 is a cross-sectional view of the display device 90 taken along line B-B. In the ninth embodiment, the display device 90 includes mark projections (marks 93) on a back surface thereof (an outer surface 94) and the projections are arranged in a staggered pattern. The marks 93 are disposed corresponding to the keys displayed on a display surface (on a back side of the keys).

### Tenth Embodiment

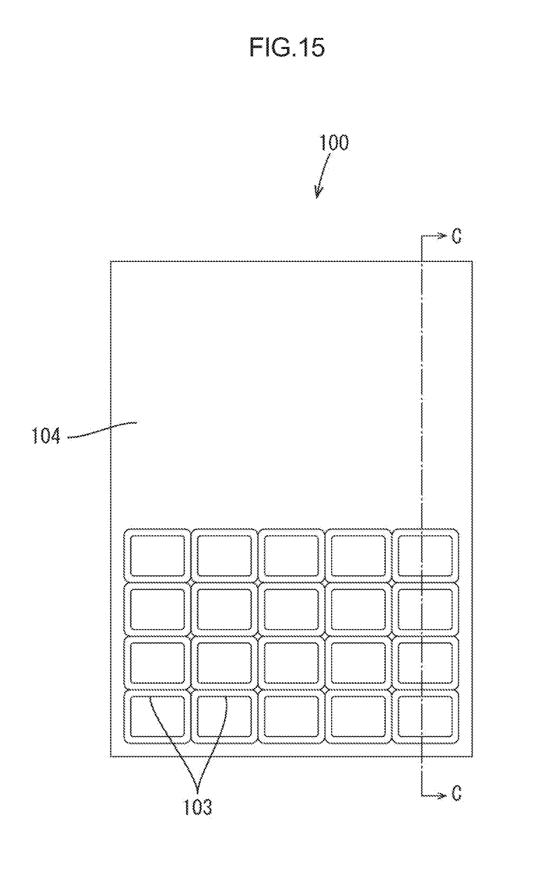

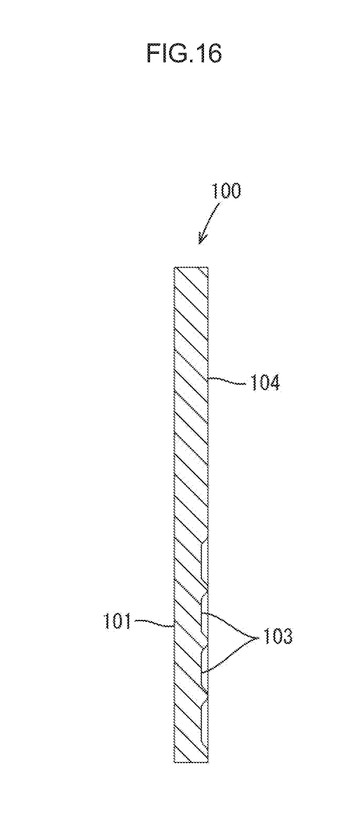

FIG. 15 is a back side view of a display device 100 according to a tenth embodiment and FIG. 16 is a cross-sectional view of the display device 100 taken along line C-C. In the tenth embodiment, the display device 100 includes mark recesses (marks 103) on a back surface thereof (an outer surface 104) and the mark recesses are disposed corresponding to all or the character input keys displayed on a display surface 101.

### Eleventh Embodiment

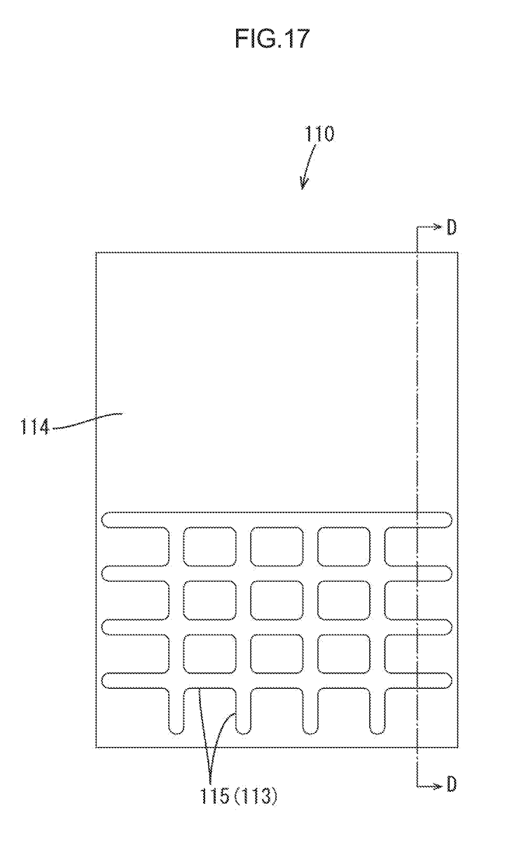

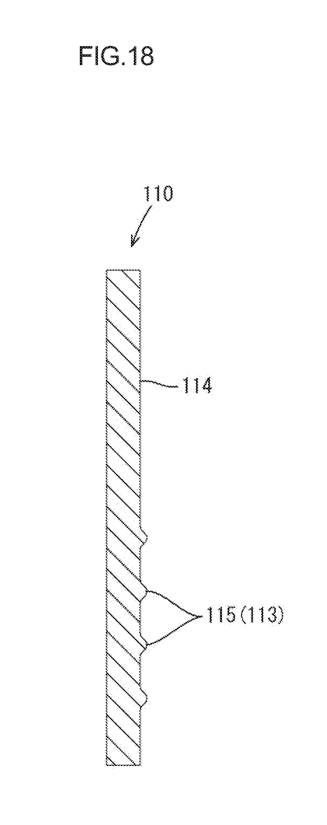

FIG. 17 is a back side view of a display device 110 according to an eleventh embodiment and FIG. 18 is a cross-sectional view of the display device 110 taken along line D-D. In the eleventh embodiment, the display device 110 includes ribs 115 (marks 113) on a back surface thereof (an outer surface 114) and the ribs 115 are disposed in a grid. Each of the ribs 115 is disposed corresponding to a border between the input keys (on a back side of each border).

### First Modification of Eleventh Embodiment

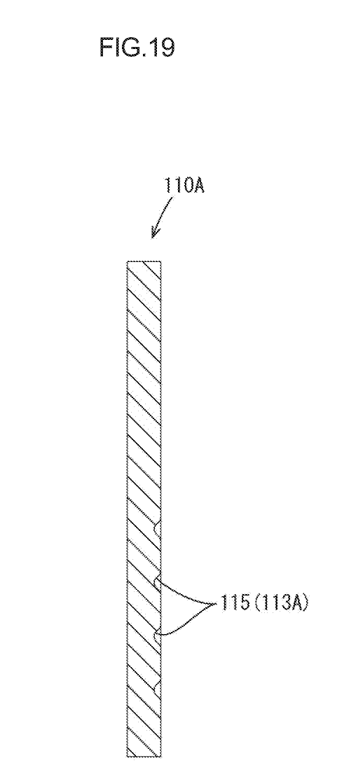

FIG. 19 is a cross-sectional view of a display device 110A including recesses 116 (marks 113A) instead of the ribs 115 of the eleventh embodiment.

### Twelfth Embodiment

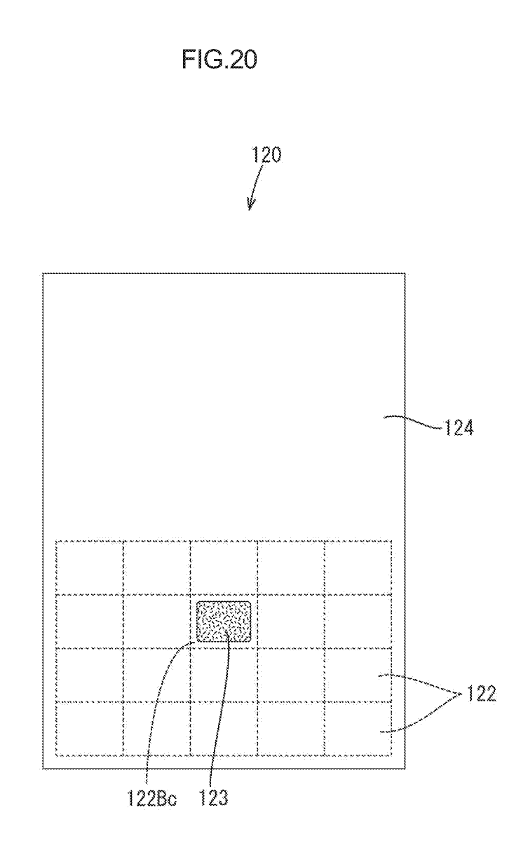

FIG. 20 is a back side view of a display device 120 according to a twelfth embodiment. In the twelfth embodiment, the device 120 includes a mark 123 on a back side surface thereof (an outer surface 124). The mark 123 has surface roughness greater than that of a surrounding portion thereof. The mark 123 has a substantially quadrangular shape that substantially covers an area of the back surface corresponding to a key 122Bc that is on a second row from the above and a third column.

### First Modification of Twelfth Embodiment

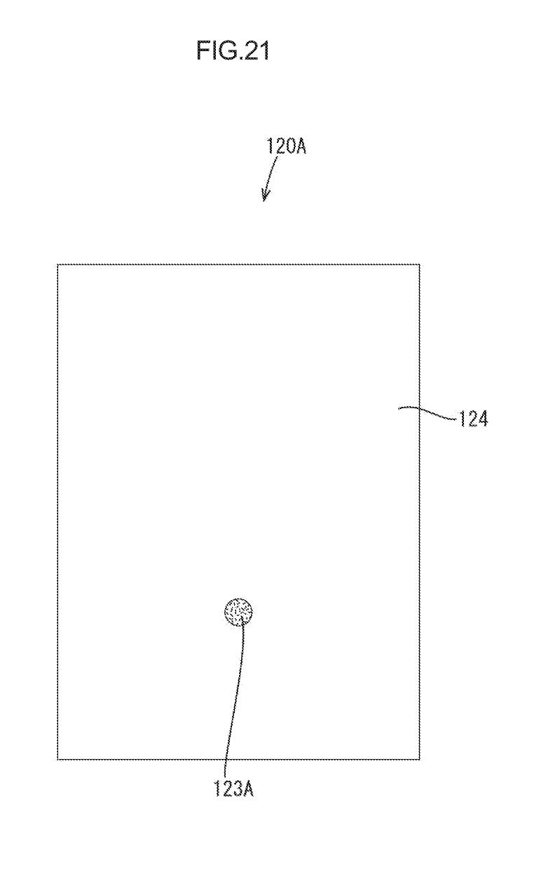

FIG. 21 illustrates a display device 120A including a mark 123A having a circular shape (a mark 123A) instead of the substantially rectangular mark 123 of the twelfth embodiment.

### Second Modification of Twelfth Embodiment

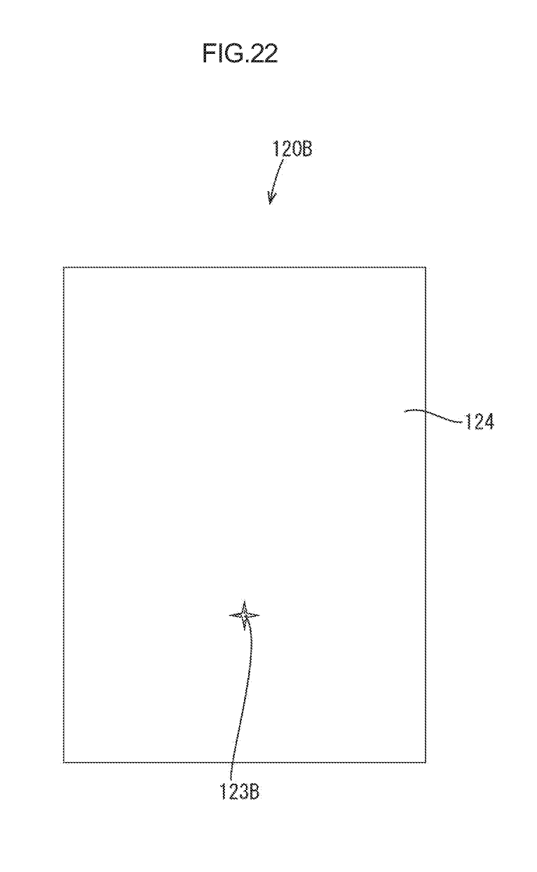

FIG. 22 illustrates a display device 120B including a mark 123B having a cross shape (a mark 123B) instead of the substantially rectangular mark 123 of the twelfth embodiment.

### Thirteenth Embodiment

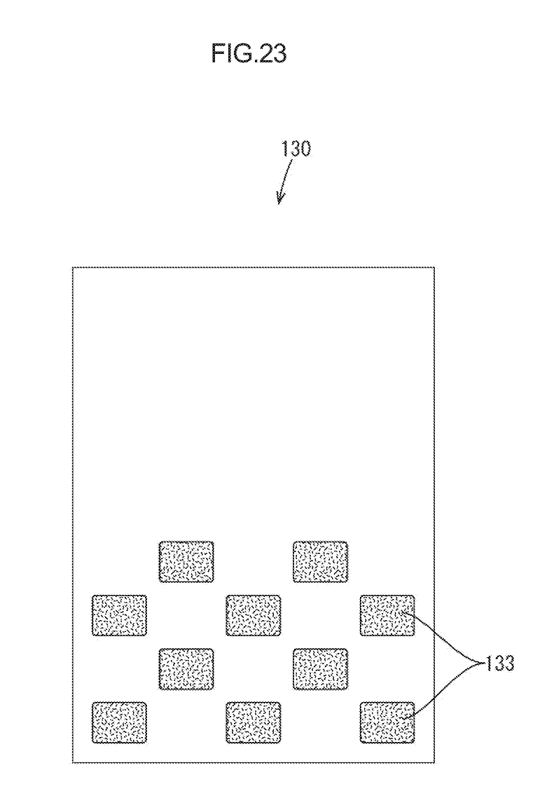

FIG. 23 is a back side view of a display device 130 according to a thirteenth embodiment. In the thirteenth embodiment, the display device 130 includes marks 133 in a staggered pattern and the marks 133 have surface roughness different from that of a surrounding portion thereof. Each of the marks 133 has a substantially a rectangular shape and is disposed (on a back side) corresponding to one of input keys displayed on a display surface.

### First Modification of Thirteenth Embodiment

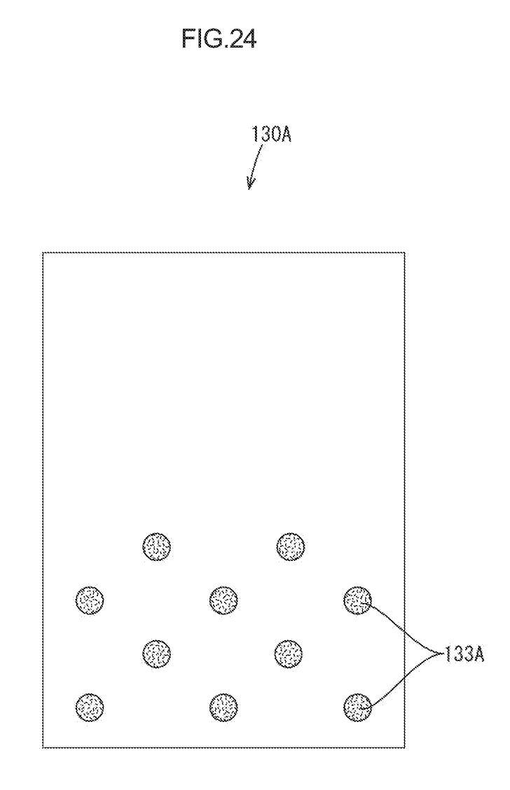

FIG. 24 illustrates a display device 130A according to a first modification of the thirteenth embodiment. The display device 130A includes marks 133A having a circular shape instead of the marks 133 having rectangular marks 133 of the thirteenth embodiment.

### Fourteenth Embodiment

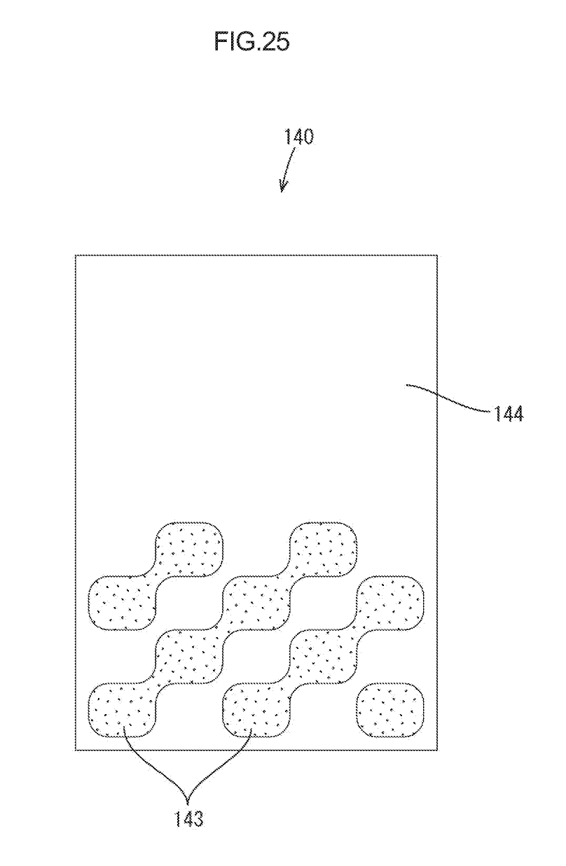

FIG. 25 is a back view of a display device 140 according to a fourteenth embodiment. In the fourteenth embodiment, the display device 140 includes marks 143 on a back side surface thereof (an outer surface 144). The marks 143 are formed of soft material such as rubber having surface hardness different from that of a surrounding portion thereof. The mark 143 is formed in a back side region of some of the keys that are displayed on a display surface. Specifically, the mark 143 is formed in the back side region corresponding to the keys that are obliquely continuous between the keys arranged in a staggered pattern.

### First Modification of Fourteenth Embodiment

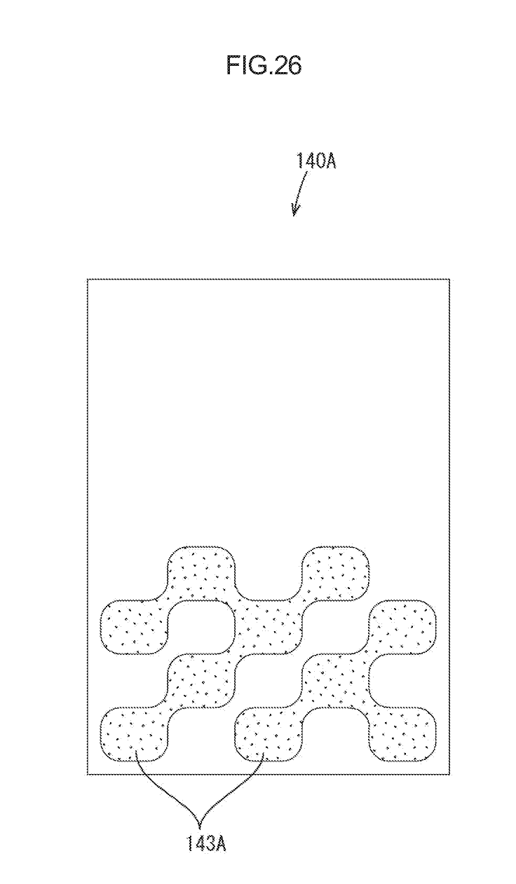

FIG. 26 illustrates a display device 140A according to a modification of the fourteenth embodiment. The display device 140A includes marks 143A and the mark 143A has a shape different from that of the fourteenth embodiment.

### Fifteenth Embodiment

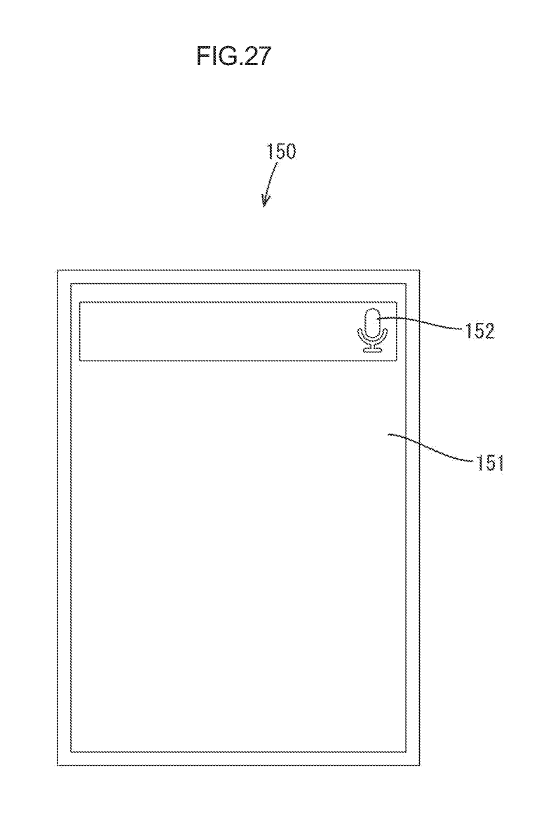

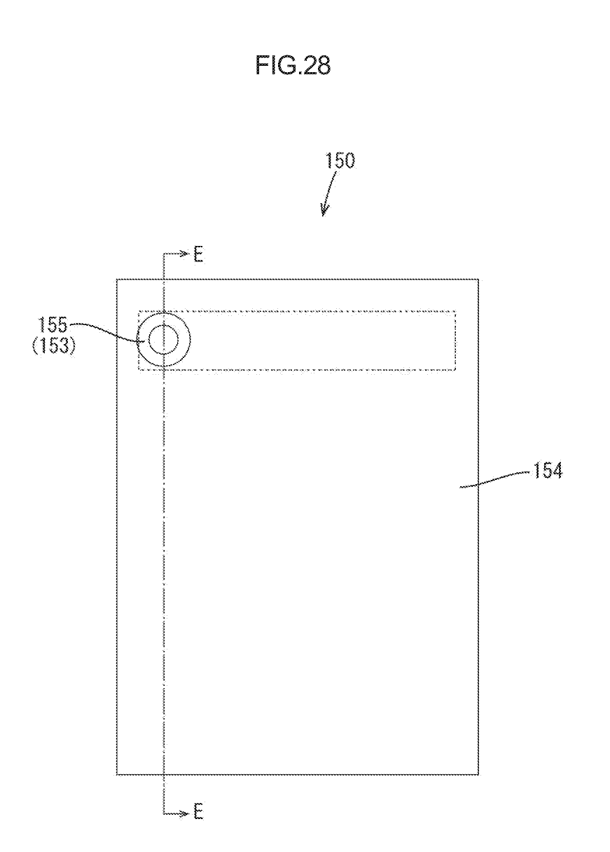

FIG. 27 illustrates a display device 150 according to a fifteenth embodiment. A voice microphone key 152 is splayed on a display surface 151 of the display device 150. FIG. 28 is a back side view of the display device 150. The display device 150 includes a mark 153 in a position of a back side surface thereof corresponding to the voice microphone key 152.

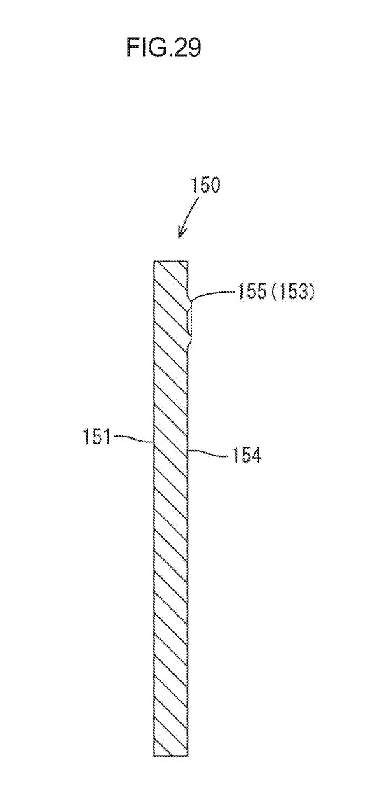

As illustrated in FIGS. 28 and 29, the mark 153 is a rib 155 (a projection) projecting from the back side surface (an outer surface 154) and the rib 155 has a ring shape. According to this embodiment, in performing voice input, a user can know a position of the voice microphone key 152 with a sense of touching the mark 153 and without visually confirming the voice microphone key 152.

### First Modification of Fifteenth Embodiment

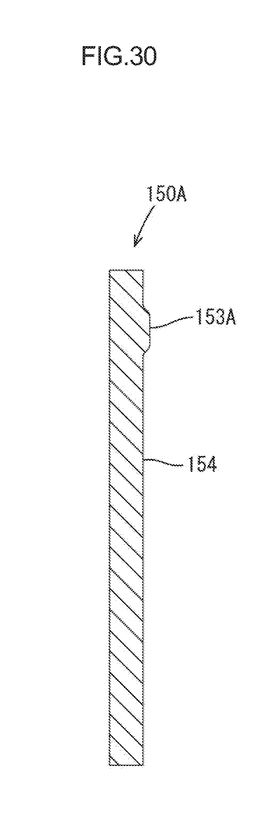

FIG. 30 illustrates a display device 150A including a mark 153A that projects from the back side surface (the outer surface 154) in a columnar shape instead of the rib 155 projecting in a ring shape as is in the fifteenth embodiment.

### Second Modification of Fifteenth Embodiment

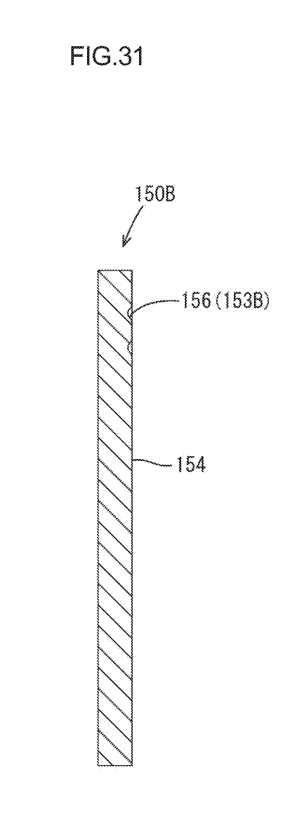

FIG. 31 illustrates a display device 150B including a mark 153B that is recessed from the back side surface (the outer surface 514) in a ring shape instead of the rib 155 projecting in a ring shape as is in the fifteenth embodiment.

### Third Modification of Fifteenth Embodiment

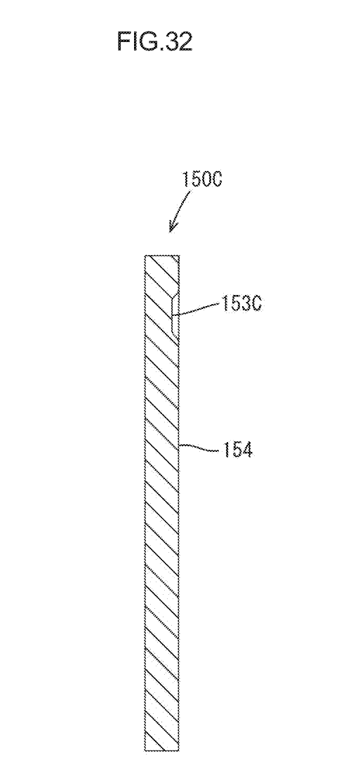

FIG. 32 illustrates a display device 150C including a mark 153C that is a recess recessed from the back side surface (the outer surface 154) instead of the rib 155 projecting in a ring shape as is in the fifteenth embodiment.

### Fourth Modification of Fifteenth Embodiment

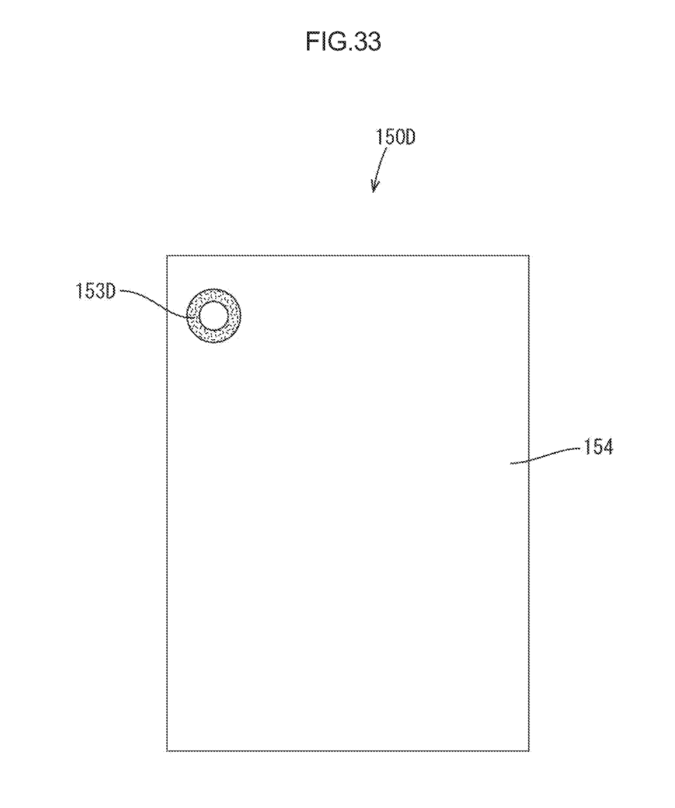

FIG. 33 illustrates a display device 150D including a mark 153D on a back side surface (the outer surface 154) instead of the rib 155 projecting in a ring shape according to the fifteenth. embodiment. The mark 153D is formed in a ring shape and has surface roughness different from surface roughness of surrounding portions thereof.

### Fifth Modification of Fifteenth Embodiment

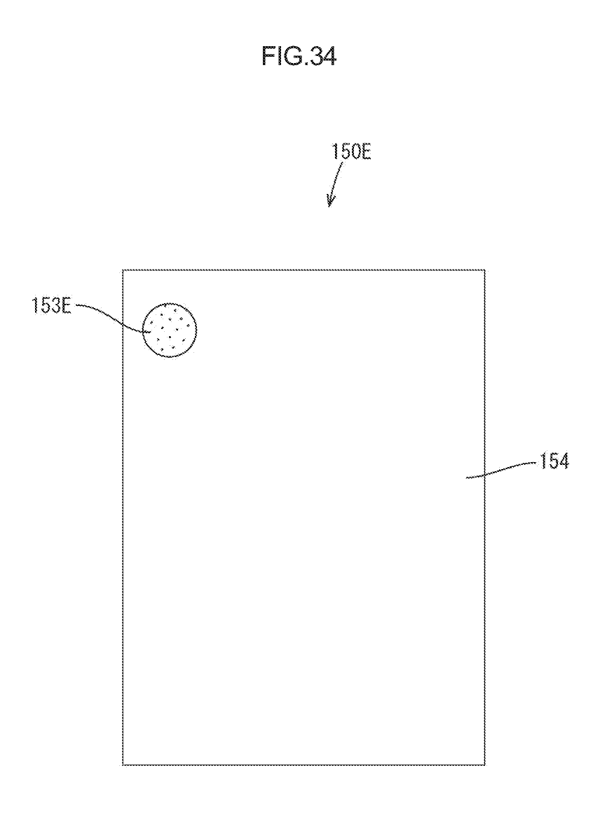

FIG. 34 illustrates a display device 150E including a mark 153E on a back side surface (the outer surface 154) instead of the rib 155 projecting in a ring shape according to the fifteenth embodiment. The mark 153E has a circular shape and has hardness different from that of surrounding portions. For example, the circular mark 153E is made of soft material such as rubber.

### Other Embodiments

The technology described herein is not limited to the embodiments described in the above sections and the drawings. For example, the following embodiments may be included in a technical scope.

(1) The display device may be not necessarily a small-sized hand-held type display device but may be a relatively large display device.

(2) The number or the position of the marks may be altered as appropriate. For example, a mark may be arranged at a border section between an edge of one of the input keys and a section other than the keys.

(3) The projection may be formed in any other shapes such as an arched shape.

(4) The surface properties of the outer surface of the display device may be changed by including a flat surface and an uneven surface.

(5) The mark may have any other two dimensional shapes For example, if the display device includes the mark on the back side surface thereof, the two dimensional shape of the mark may be a company logo, illustration, or a part of them. Namely, the mark may have any shape as long as it can be recognized with a sense of touching from surrounding portions thereof.

(6) The mark may be included in a cover of a display device including the cover as an outer surface.

1. A display device comprising:
a display surface displaying information thereon; and
an outer surface different from the display surface, the outer surface including a mark providing a sense of touching different from a sense of touching a surrounding portion thereof such that a touching position of the display device is recognized.

2. The display device according to claim 1, wherein the mark is included at a positon of the outer surface corresponding to at least one of virtual keys displayed on the display surface.

3. The display device according to claim 1, wherein the mark is a projection projecting from the outer surface.

4. The display device according to claim 1, wherein the mark is a recess recessed from the outer surface.

5. The display device according to claim 1, wherein the mark has a surface property different from that of the surrounding portion thereof.

6. The display device according to claim 1, wherein the mark has hardness different from that of the surrounding portion thereof.

7. The display device according to claim 1, further comprising a cover configured as the outer surface, the cover including the mark.
